(19) United States
(12) Patent Application Publication
(10) Pub. No.: US 2002/0143724 A1
(43) Pub. Date: Oct. 3, 2002

(54) Method, system and computer program product to partition filter rules for efficient enforcement

(75) Inventors: Everett Arthur Corl JR., Raleigh, NC (US); Gordon Taylor Davis, Chapel Hill, NC (US); Clark Debs Jeffries, Durham, NC (US); Victoria Sue Thio, Cary, NC (US); Colin Beaton Verrilli, Apex, NC (US); Avraham Zehavi, Naharia (IL)

Correspondence Address: Joscelyn G. Cockburn, IBM Corporation 2Y7/B656, PO Box 12195, Research Triangle Park, NC, 27709, US

(73) Assignee: International Business Machines Corporation, Armonk, NY (US)

(21) Appl. No.: 09/761,939

(22) Filed: Jan. 16, 2001

(51) Int. Cl. G06F 7/00

(52) U.S. Cl. 707/1

(57) ABSTRACT

The effectiveness of a Network Processor to process data at media speed is enhanced by partitioning a Rules Database, used to filter and/or forward frames, into at least one set of Almost-Exact Rules and Other Rules. The Almost-Exact Rules are processed by a Full Match (FM) Tree Search Algorithm and the Other Rules are processed by a Software Managed Tree (SMT) algorithm.

### BACKGROUND OF THE INVENTION

1. Technical Field

The present invention relates to computer databases in general, and in particular, to databases used by network processors in communications networks.

2. Prior Art

The use of databases in computers and communications networks are well known in the prior art. In a conventional computer system the database includes a plurality of entries. An unknown item is correlated with the database. If the unknown item matches an entry in the database a predetermined action associated with the entry is taken relative to the unknown item.

In the communications network the database contains a plurality of rules which are applied against IP packets received from the internet and for other frames received from other communication facilities or devices. Each rule is associated with a predetermined action. If a rule fits the received packet or frame, the predetermined action, associated with the rule, is applied to the packet or frame. The predetermined action may include routing decision, filtering decision, etc. Prior art information relating to Rules databases and usage in security, filtering, etc. are set forth in:

U.S. Pat. Nos. 6,088,805

6,076,168

6,009,475

6,047,377

5,720,033

5,996,077

5,951,651

5,848,233

The generation of the Rules database is a preprocessing event in which an administrator inputs the rules into the database. Application of the rules to an IP packet or frame is a real time event done at media speed. To meet the media speed requirement the testing of packets must be done expeditiously and at rapid speed. None of the prior art solves this problem. Therefore, there is a need to provide devices, methods and programs that maximize the rate at which a rules database is applied to network packets and/or frames.

### SUMMARY OF THE INVENTION

The present invention provides a Rule database and uses an algorithm to partition the rules database into “Almost-Exact Rules” (described hereinafter) and Other Rules. A Full Match (FM) algorithm tests portion of a packet called a key against the Almost-Exact Rules. A Software Managed Tree Algorithm (SMT) tests the key against the other Rules. Both keys and rules have components or fields, typically including Source Address (SA), Destination Address(DA), Source Port (SP), Destination Port (DP), and Protocol (P). If a Rule fits the key, then the action associated with the Rule is applied to the key. In each field a rule might require that the key field is an exact match of a value, or might require that the key field lies in a certain range of values, or might require nothing.

No two rules in the present invention are identical.

The present invention includes the concept of an initial partitioning mechanism of rules into

1. A set of n=one or more special components or fields such as Destination Port.

2. For each special component i=1, 2, . . . , n, a maximal set of almost-exact rules {AEi} labeled AE1, AE2, . . . , AEn each with the property that all components of AEi are fixed except that component i is wildcard. (For some components i=1, 2, . . . , n, the set AEi might be empty.)

3. A complementary set of rules labeled C consisting of all rules that are not included in the sets of rules AE1, AE2, . . . , AEn defined by 1 and 2.

In this embodiment, an algorithm then examines all sets AE1, AE2, . . . , AEn and all rules in some sequence in each AEi and moves any such rule from its AEi and to C if it intersects with and is dominated by some rule not in its AEi. The invention further includes an algorithmic step in which every set of almost-exact rules that contains fewer members than a predetermined threshold may be merged with the complementary set of rules C.

Given such a partition and application of such an algorithm resulting in rule sets AE1, AE2, . . . , AEn, the present invention also includes a total of n separate Full Match Trees (FMTs) corresponding to the sets of almost-exact rules AE1, AE2, . . . , AEn.

The present invention also includes one Software Managed Tree (SMT) for the rules in the complementary set C. Alternately, the complementary set C may be searched using a Content-Addressable Memory (CAM). This alternative results in higher performance, but adds cost to the system.

If no rule in a set AEi intersects with any other rule in any AEj or in C, then the above FM and SMT tests can be carried out in parallel without consideration of priority of rules among the test systems. (It still can happen that a key fits two or more rules in C and those rules within C must be considered with their priorities.) Typically, the almost-exact rules reflect numerous special permissions bestowed on exact combinations of SA, DA, SP, P—with DP being the wildcard component—and may possibly overlap other rules in set C. In this case, the searches may be done serially (FM first), or in parallel. If done in parallel, it is understood that a result from the FM search will likely complete first and that the SMT search may be cancelled when the FM search returns a match.

By partitioning the Rules database in accordance with teachings of the present invention the speed with which data is processed (e.g. filter route etc.) is increased. Likewise, the data throughput of the system is increased.

### BRIEF DESCRIPTION OF THE DRAWINGS

FIG. 1 schematically illustrates a communications network in which the present invention is used.

FIG. 2 shows a flow chart schematically illustrating operations of the present invention.

FIG. 3 shows a structure that tests an Input Packet or Frame against the partitioned database.

FIG. 4 shows a schematic of the database structure and a schematic of the key.

FIG. 5 shows a flow chart illustrating in detail Block 40 of FIG. 2.

FIG. 6 shows a flow chart illustrating in detail Block 42 of FIG. 2.

FIG. 7 shows a flow chart illustrating in detail Block 44 of FIG. 2.

### DETAILED DESCRIPTION OF THE PREFERRED EMBODIMENT

The present invention can be used in any environment in which optimization of a database is required to enhance the speed at which an item is tested against entries in a database. It works well in communications networks and will be described in that environment. However, this should not be construed as a limitation on the invention since it is within the skill of one skilled in the art to apply teachings of the present invention to other areas. To fully understand the invention a description and definition of terminologies is given followed by more detailed description of the invention.

In developing a connection to a network, administrators can create filter rules for network security. In general, information in the headers of an IP packet is used to make a key (fixed length binary string). The key is tested by a filter rule and if the rule fits, the action of the rule (such as permit or deny passage of the packet) is applied. The rule applies to various fixed length components of the key such as IP Source Address (SA), IP Destination Address (DA), Source Port (SP), Destination Port (DP), Protocol (P), or other components in fixed positions in packet headers. The rule might or might not have a restricted set of values in each component (as opposed to all possible binary values of the given length). If the rule has a restricted set of values in a component, then the key fits that component if and only if the binary values of the key lie in the set of rule values. A key fits a rule if and only if all components of the key lie in the respective component ranges of the rule. Two rules intersect if at least one key fits both. If a key fits two or more rules, then the administrator must declare priorities among rules that guarantee logically consistent actions will be the outcome of the several fits. The testing of a key relative to a set of filter rules and the application of the stored action or actions associated with rules that the key fits is called enforcement of the set of filter rules.

If the range of values in a component of a rule is exactly one value, then that component of the rule is called an “exact component.” If all the components of a rule are exact, then the rule is called an “exact rule.”

If the range of values in a component of a rule is all possible binary values of the component length, then that component of the rule is called a “wildcard component.” Values in a wildcard component are ignored, that is, they are not tested when seeking a rule fit.

It can happen that some rules have ranges in two or more components of a key or, having a range in only one component, might not include all possible values in that one range component. Such rules are called herein “range rules.” In general, sets of range rules include some rules that intersect. Also, sets of range rules in general are difficult to administer because it can be not obvious which rules apply to various keys. One method of testing keys relative to such sets of intersecting rules is described in “Software Management Tree Implementation for a Network Processor,” serial number 09/545,100 (docket RAL9-1999-0141), that is incorporated herein by reference.

It can also happen that some rules have ranges on only one component of a key, for example, there might be a thousand rules in which every component is exact except for the Destination Port number in every rule, which is in every one of the thousand rules a wildcard component. Let us call a set of such rules with given common wildcard component “almost-exact rules.” Given that no two rules are identical, in a set of almost-exact rules, it can be proven that no two of any such rules intersect. One method of testing keys relative to such sets of nonintersecting rules is first hashing fixed components of all the rules, preferably a hash like the geometric hash described in “Hash Function for IP, MAC, and Other Structured Addresses”, serial number 09/210,222 (docket RA9-98-056), incorporated herein by reference. Then the key can be hashed in the same way and can be processed by the Full Match Tree (FMT) method set forth above and incorporated herein by reference.

If many almost-exact rules are mixed with other rules, then the combined set can be difficult to enforce at high speed in a single, low cost, unified lookup mechanism. The present invention sets forth techniques to partition the rules to speed enforcement in low cost mechanisms.

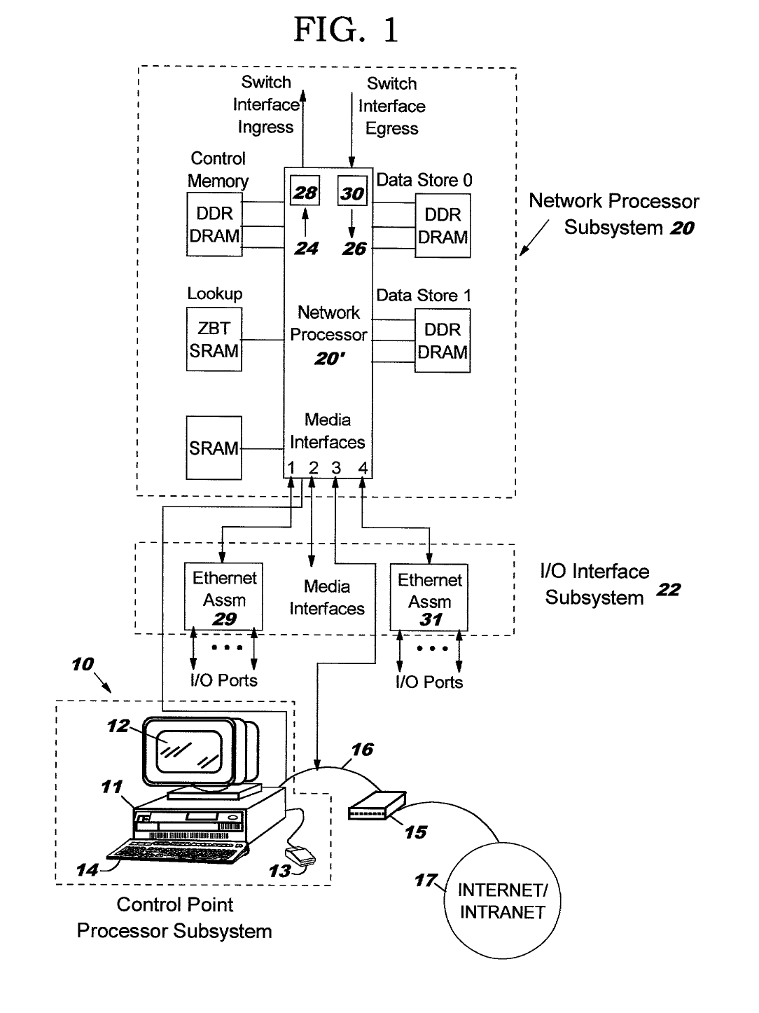

FIG. 1 shows a schematic of a communications network embodying the teachings of the present invention. The communications network includes network processor subsystem 20 connected by I/O interface subsystem 22 to control point processor subsystem 10 and internet/intranet subsystem 17. The communications system shown in FIG. 1 is a complex system. Therefore, only those parts that are relevant to the invention set forth below will be described. The present invention, set forth below, is implemented in the control processor subsystem 10 and in the network processor subsystem 20.

Still referring to FIG. 1, the network processor subsystem 20 includes network processor 20′ which is coupled by media interfaces to I/O interface subsystem 22 and appropriate interface to data store 0, data store 1, SRAM, lookup and control memory. The network processor has an Ingress side for data flowing from the media interface into the chip and an Egress side for data flowing from the chip to the media interface. The respective data flows in the chip are shown by arrow 24 indicating the Ingress side data flow and arrow 26 indicating the Egress side data flow. A parallel to serial circuit arrangement 28 hereinafter called Switch Interface is positioned at a location whereat ingress data exits the network processor. A second Switch Interface 30 is positioned at the point whereat data from the Ingress side enters the Egress side of the network processor. Conductors labelled Switch Interface interconnect the Ingress and Egress sections of the network processor to a switch fabric. Alternately, in a single network processor configuration, the Switch Interface may be looped back to itself. The network processor, among other things, provides filtering functions, routing functions, etc. A more detailed description of the network processor is given in the Power NPtm documentations which are incorporated herein by reference. The Power NP and documentations are developed by IBM_{(R)} Corporation.

The Power NP includes a plurality of programmable protocol processors. The protocol processors are grouped into sets of two and each set shares hardware coprocessors which operate in parallel with the protocol processor. In particular, one of the coprocessors is customized to undertake tree searches to test keys received from the network against a database which is stored in the memory. In the preferred embodiment the databases are generated in accordance with the teaching of the present invention and stored as Patrica trees in the memory. The customized coprocessor, hereinafter called the tree search coprocessor, utilizes either the Full Match Tree algorithm or the Software Managed Tree algorithm to test a key, described hereafter, with the database which is stored in the memory.

Turning to FIG. 4 for the moment, a schematic of the database according to the present invention is shown. The database includes N entries R0 through RN-1. Each entry has sub-fields SA (Source Address), DA (Destination Address), SP (Source Port), DP (Destination Port), Protocol Type, and Action. More generally, some databases might include another combination of fields or other fields. As stated previously, databases are generated by an operator at the control point processor subsystem 10 (FIG. 1) and downloaded into the network processor. According to the present invention the databases are compiled based upon the characteristics of the sub-field. In essence, rules that are almost-exact are stored in one database with a full match search method. All other rules are stored in another database with another type of search method such as SMT. It should be noted that generating databases is a pre-processing non-realtime procedure whereas testing is a realtime procedure.

Still referring to FIG. 4, in communications terminology the source address, destination address, source port, destination port and protocol type sub-fields are referred to as the IP Five-Tuples. Five-Tuples are sub-fields of an IP frame and can form the key that is used to test against the rules database. If the test is successful then the action associated with the rule is applied to the key. If the test is unsuccessful, then a default action would be enforced.

Referring again to FIG. 1, the I/O interface subsystem 22 includes a plurality of media interfaces which connects the network processor to I/O devices and systems. Included in the interface subsystem 22 are Ethernet assembly 29 and Ethernet assembly 31 The Ethernet assembly provides I/O ports to which I/O devices (not shown) can be connected. To this end the Ethernet assemblies include Ethernet Medium Access Control (MAC) functions, physical and other components necessary to connect stations to the network processor. In one embodiment of the invention ports can provide data rate of 10/100 Mb/s or 1 or 10 Gb/s. Of course other speed ports, and other media types (i.e. Packet over Sonet), can be provided without deviating from the spirit of the present invention. Another one of the media interfaces is connected by conductor 16 and modem 15 to the internet/intranet system 17. With this connection the network processor has access to process IP frames provided by other stations (not shown) connected to the internet/intranet.

Still referring to FIG. 1, another one of the media interfaces interconnects the network processor to control point processor subsystem 10. The control point processor subsystem 10 includes a display monitor 12, control unit 11, keyboard 14 and a pointer unit such as a mouse 13. The use of these devices for entering information into a system is well known. Therefore, only the portion that is relevant to the present invention will be described in further detail. Some of the function necessary for the operation of the network processor is performed in the control point processor. To this end the control point processor, among other things, provides layer 2 and layer 3 routing protocols, layer 4 and layer 5 network applications and system management. The wire speed filtering and forwarding functions are provided in the network processor by network processor hardware and resident picocode (a version of Assembler enabled by the network processor). The present invention which segregates database information based upon a characteristic of the sub-field enhances the ability of the network processor to do these wire speed functions even though the rules databases are ordinary memories. The cost of ordinary memories is much less than high performance memories. Therefore, the overall cost of the system is much less than it would be if high performance memories had to be used. The cost benefit is a direct result of the present invention.

Still referring to FIG. 1, search data structures are downloaded into the network processor after generation by a network administrator on the control point processor. The software in the control point processor includes an operating system, at least one software driver which interfaces the operating system to the network processor and a plurality of application programs being executed in the control unit 11. One of these application programs could be the program (described hereinafter) which is used to partition the database. The partition is based upon the characteristics of the sub-fields of each rule in the rules database.

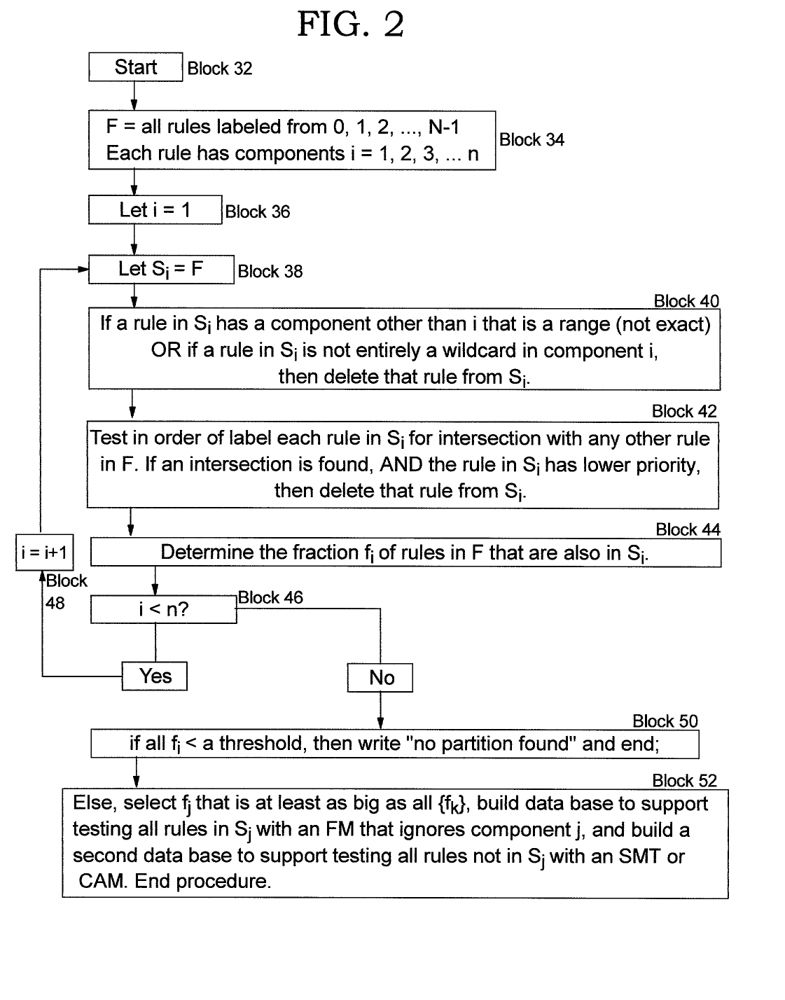

FIG. 2 shows a flow chart of the application program, algorithm, used to process the database and produce the desired partition. As stated previously, the database is generated at the control point processor in FIG. 1. Rules might be entered one by one in response to evolving security policy or other policy, or rules might be entered in batches. As a consequence the algorithm is executed on the control point processor. The rules database may contain mixed information in which some rules have exact, range, or wildcard types of sub-fields. The algorithm partitions the database so that almost-exact rules are placed in one database and are processed with a fixed match algorithm in the network processor and the other types of rules are placed in a second database and is processed with an SMT algorithm or other mechanism in or attached to the network processor.

Still referring to FIG. 2, block 32 of the program indicates the entry block where the process is entered. The program then descends into block 34 where F is made equal to all rules R0, . . . , RN-1 (FIG. 4). Each rule in the database has components also called sub-fields i=1,2,3 . . . n. The program then proceeds into block 36 whereat i is set equal to 1. This means that the first component hereafter called field in each rule will be examined. The program then proceeds into block 38 whereat the rules are grouped into sets and examined. In block 38, Si, with S representing set, is made equal to F. The program then proceeds into block 40. All the rules in Sᵢ are examined. In block 40, if a rule in Sᵢ has a component other than i (the column that is being examined) that is a range (not exact), then that rule is deleted from Sᵢ. Furthermore in block 40, if a rule in Sᵢ has its component i other than a widcard component, then that rule is deleted from Sᵢ. The program then proceeds into block 42. In block 42 the algorithm tests in order of label each rule in the set Sᵢ for intersection (multiple rules matching one key) with any second rule in F. If an intersection is found and if the second rule in F has higher priority, then that rule in Sᵢ is deleted from Sᵢ. In an alternative embodiment, if all rules remaining in Sᵢ already have priority number 1 (so dominate all rules with which they intersect), then Block 42 is deleted. The program then proceeds into block 44 whereat the percentage or “fraction” fi of rules remaining in Sᵢ divided by the total number N of rules in F is determined. The program then proceeds into block 46 whereat the component index i is compared to the number of components n. If i is less than T, then the process increments by setting i equal to i+1. The program then repeats steps in block 38 through block 46.

When i =n the program exits block 46 along the No path into block 50. If all the fractions fi in block 50, previously calculated in block 44, are less than a threshold T set by the administrator, then partitioning the database may not be beneficial and the program exits the routine. If one or more of the fi equals or exceeds the threshold T, then the program proceeds into block 52 whereat a set of rules Sₖ with an fk exceeding or equal to the threshold T and typically being at least as large as any other fraction determined in block 44 is placed in the first database and is processed with FM algorithm. All rules in F and not in Sₖ are placed in another database and are processed with SMT algorithm. Alternatively, this procedure may be extended to include multiple FM databases in cases where several almost-exact sets were above a predetermined threshold. In this case, the additional FM searches would be done in parallel, with the assurance that there are no overlapped rules among the multiple sets of almost-exact rules. Any of the almost-exact rules would take precedence over any of the range rules.

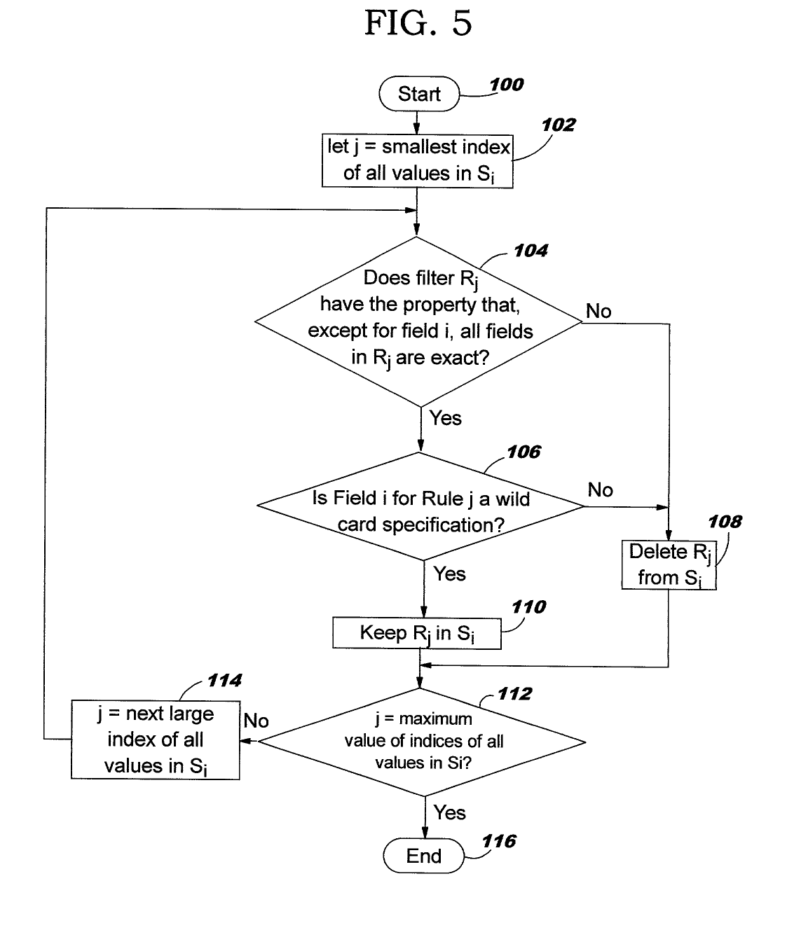

FIG. 5 shows details of block 40. It starts at block 100. Block 102 is a loop through an index for all the filter rules present in the set of filter rules. Block 104 tests each rule whether or not every field in a rule is exact except possibly field number i. If yes, descend to block 106 and keep the rule in the current subset of rules Sᵢ. If no, branch to block 108 and delete the rule from the current subset of rules Sᵢ. If yes, branch to block 106. In block 106, test the rule for the property that field i is wildcard. If no, branch to block 108. In block 110 keep the rule in rule set Sᵢ. In block 112, test the label of the rule for maximum possible value of rule indices in set Sᵢ. If not the maximum value, increment j in block 114 and return to block 104. If j is the maximum value, then branch to block 116 and end.

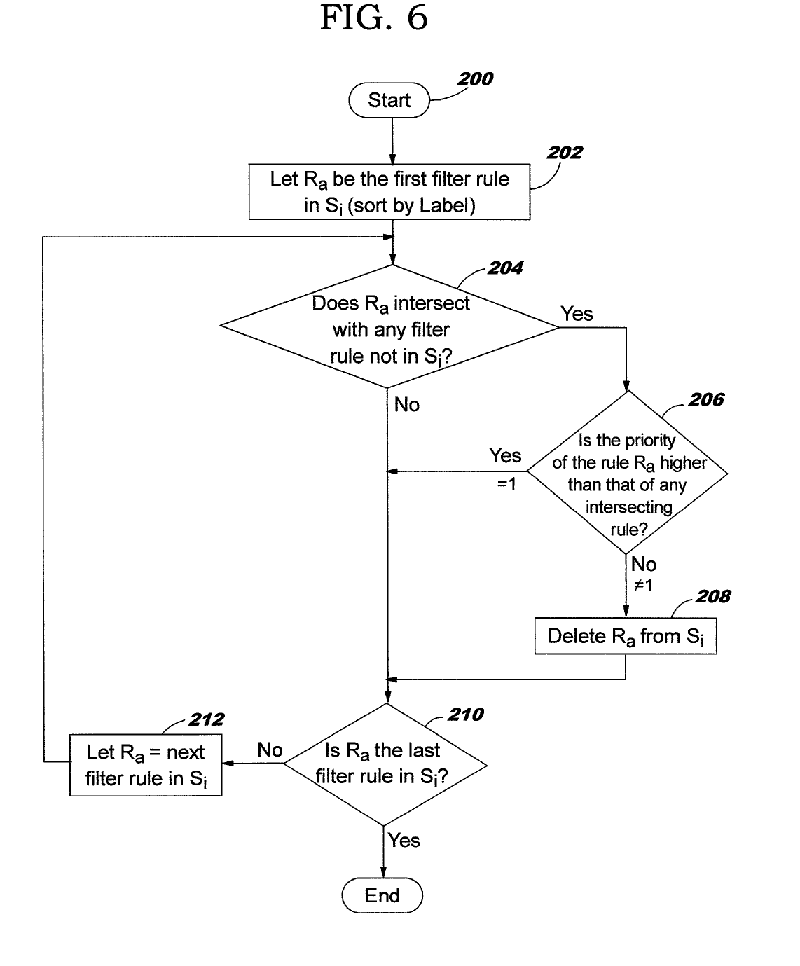

FIG. 6 shows details of block 42. Start in block 200 with a chosen field i and subset Sᵢ of some filter rules. Sort the filter rules and treat them sequentially as follows. Order is arbitrary. In block 202 choose the first filter rule. In block 204 test it for intersection with all other filter rules not in Sᵢ. If no, then branch to block 210. If yes, then branch to block 206. In block 206, test the rule for the property that its priority number is 1, with 1 being the highest priority. If yes, then branch to block 210. If no, then branch to block 208. If intersection exists, branch to block 208 whereat Ra is deleted from Sᵢ. In block 208, delete the rule from Sᵢ and go to block 210. If in block 210 the rule is not the last filter rule, branch to block 212. If the rule is the last, branch to block 214 and end. In block 212, select the next filter rule, then return to block 204.

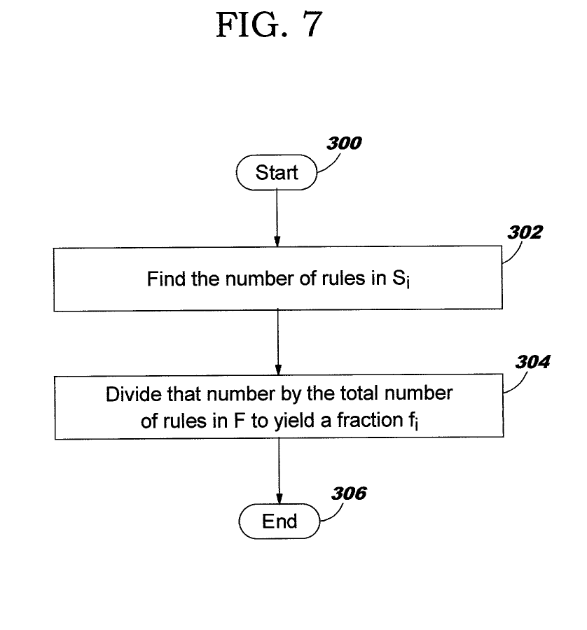

FIG. 7 shows details of block 44. Start in block 300 with a subset of rules Sᵢ and a chosen field with index i. Go to block 302 and find the number of rules in Sᵢ. Go to block 304 and divide that number by the total number of rules in the entire filter rule database F and let fi be the resulting fraction. Then branch to block 306 and end.

An example of how the algorithm works will now be given. Turning to FIG. 4 for the moment, suppose N=4 and n=5. An example of such a rule set consists of four rules R0 through R3.

R0 has components 5, 6, *, 11, 44

R1 has components 1, 2, *, 2, 2

R2 has components 0, 0, *, 7, 10

R3 has components 1 through 7, *, 12, 44 through 47, 52

When the algorithm is applied to the database the Sᵢ and fi values shown in Table 1 below are generated.

TABLE 1

| | |
|---|---|
| 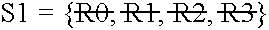 | f1 = 0% |
| 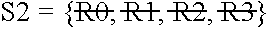 | f2 = 0% |
| 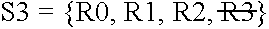 | f3 = 75% |
| 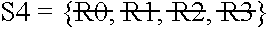 | f4 = 0% |
| 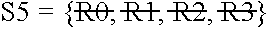 | f5 = 0% |

To generate S1 the values in field 1 of the Rules set must be wild card and other fields must be exact. As is evident by looking at the database, all the rules must be deleted from S1, as shown. The fraction f1 is then generated and since we started off with four rules and none remains, the percentage f1 is 0 percent. It should be noted that the threshold for partitioning the database would typically be set much higher than 25 percent. Therefore, in the first field labe choice (field 1), it would not be productive to partition the database. A similar result holds for the S2 set. The process of ignoring a column and testing which rule has all exact values in the sub-field is continued until S3, S4 and S5 are obtained. The percentages are also determined and f3 is equal to 75 percent, f4 0 percent and f5 equal to 0 percent. Suppose the threshold is 75 percent. Because only f3 meets the threshold requirement, the rules associated in S3, namely {R0, R1, R2 }, are placed into one database S₃ and are processed with an FM algorithm. The other rule remaining, R3, is processed with some other method such as an SMT algorithm.

Referring again to FIG. 1 the databases are generated in the control point processor and downloaded into the network processor. In the network processor keys are formed from IP packets received from the internet or other external point and tested against the rules databases using the designated FM or SMT algorithm.

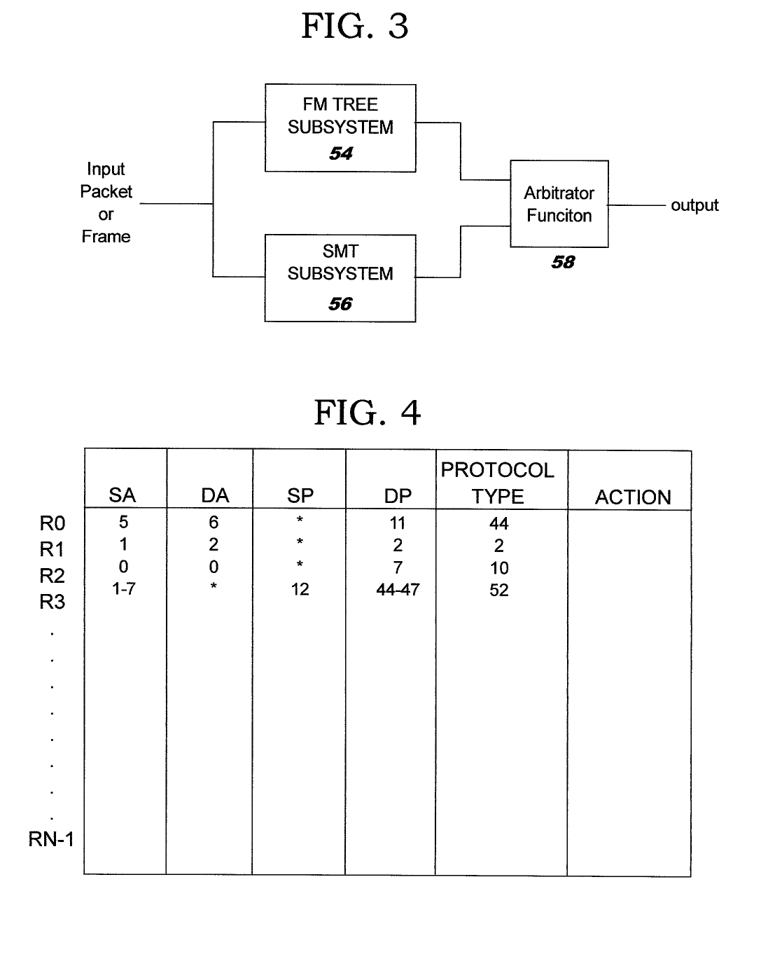

FIG. 3 shows a circuit arrangement implemented in the network processor for testing IP packets from the network against the downloaded database using the appropriate algorithm. To this end the circuit arrangement has FM tree subsystem 54 and SMT subsystem 56 connected to an Arbitrator function 58. The FM tree subsystem 54 includes the appropriate tree structure storage with the downloaded almost-exact database calculated at the control point, the tree processor and FM algorithm. SMT subsystem 56 includes the same structure as 54 except the algorithm is the Software Managed Tree algorithm. Alternatively, the function of subsystem 56 may be accomplished using a CAM.

In operation an IP packet from the network is received on the wire labelled Input Packet or Frame. The IP Five-Tuple of the packet is used as a key or some other key is defined. The key is transmitted to FM Tree subsystem 54 and SMT subsystem 56. The appropriate tree subsystem tests the key and outputs its result on associated conductor into Arbitrator Function 58. Generally, the Arbitrator will: receive the FM result before the other; if so it can logically declare the first received result and action to be the result and action of the combined system and halt any further processing of the key by the search system. The output will be outputted on the line marked Output. It should be noted that the structure in FIG. 3 is only one example of implementing the circuitry in the network processor and this showing should not be construed as a limitation on the scope of the invention. Alternatives in block 56 include use of CAM for the range rules, accommodating overlapped rules by assigning priorities to the search algorithms, use of multiple almost-exact partitions, merging several wildcard fields into a single larger wildcard field to extend applicability of almost-exact partitions, etc.

The present invention provides several benefits. Among the benefits are the use of ordinary memory for storing the database, yet still the network processor processes data at high speed.

Another benefit is the reduced cost of memory; otherwise, expensive memory would have to be used in order to process rules at high speed.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teaching and advanced use of this invention. Accordingly, all such modifications are intended to be included within the scope of this invention as defined in the claims.

What is claimed is:

1. A method comprising the steps of:
(a) providing a database of rules;
(b) applying an algorithm to the database to identify Almost-Exact Rules and Other Rules;
(c) partitioning the database so that the Almost-Exact Rules are grouped into one or more groups;
(d) partitioning the database so that the Other Rules are grouped in at least one separate group.

2. The method of claim 1 further including the step of using FM search algorithm to test packets with the Almost-Exact rules in the one or more groups.

3. The method of claim 1 further including the step of using an SMT algorithm to test packets with the Other rules in the separate group.

4. The method of claim 1 further including the step of using a Content-Addressable Memory (CAM) to test packets with the other rules in the separate group.

5. The method of claim 1 wherein the database of rules is being partitioned as a function of fields within each rules.

6. A Network Processor comprising:
a first database storing filter rules or other classification rules that are exact in all fields except one;
a second database storing other filter rules or other classification rules;
a first search function receiving an IP packet and testing a portion of said packet against the first database;
a second search function receiving an IP packet and testing a portion of said packet against the second database; and
an Arbitrator function responsive to signals from the first search function or the second search function to output an action signal if a match is found.

7. The Network Processor of claim 6 wherein the first search function includes a Full Match (FM) algorithm.

8. The Network Processor of claim 6 wherein the second search function includes a Software Managed Tree (SMT) algorithm.

9. The Network Processor of claim 6 further including a third search function receiving an IP packet and test a portion of the packet against the second database.

10. The Network Processor of claim 9 wherein the third search function includes Content-Addressable Memory.

11. The Network Processor of claim 6 further including a control processor operatively connected to the Network Processor wherein said control processor is programmed to generate the first database and the second database.

12. The Network Processor of claim 6 wherein the first database and the second database are partitioned from a common database.

13. A program product comprising:
media on which computer instructions are recorded, said instructions including a first code module that parses database of rules and partitions said database into n sets, wherein n represents number of fields in each rule of said database;
a second code module that interrogates the n sets and deletes from each set rules not meeting a first predetermined criteria;
a third code module that interrogates remaining rules in each set Sᵢ, i=1, 2, . . . , n, to determine said remaining rules are what fraction fᵢ of the rules in the database;
a fourth code module that interrogates fᵢ for each set Si;and
grouping rules associated with fᵢ, if said fᵢ meets a second predetermined criteria, into one or more groups and other rules into at least one separate group.

14. The program product of claim 13 wherein the one or more groups include Almost-Exact rules defined relative to a chosen field i.

15. The program product of claim 14 wherein the separate group includes all other rules.

16. The program product of claim 14 further including a Full Match (FM) algorithm that tests a key against rules in the one or more groups.

17. The program product of claim 14 wherein a Software Managed Tree (SMT) algorithm tests the key against rules in said at least one separate group.

18. The program product of claim 14 wherein a Content-Addressable Memory tests the key against rules in said at least one separate group.

19. A method comprising the acts of:
providing a database of rules;
partitioning, with an algorithm, said database of rules into n sets, where n represents number of fields in each rule;
reducing the number of rules within each set based upon characteristics of fields within each rule;
for remaining rules in each set, Sᵢ, with i−1, 2, . . . , n, calculate a fraction fi,
$$fi = \frac{Number of Rules in set {S}_{i}}{\begin{matrix}Total Number of Rules \\ In Database\end{matrix}} ;$$
setting a predetermined threshold T;
if fi meets or exceeds the predetermined threshold T, then partitioning rules into at least one group Sᵢ and all other rules into at least one separate group.

20. The method of claim 19 further including the act of using a Full Match (FM) algorithm to test a key against rules in the at least one group.

21. The method of claim 19 further including the act of using a Software Managed Tree (SMT) algorithm to test a key against rules in the at least separate group.

22. The method of claim 19 further including the act of using a Content-Addressable Memory algorithm to test a key against rules in the at least separate group.

23. The method of claim 19 wherein the act of partitioning includes testing of the i^{th} field of each rule and only allowing to remain the rules with a wild-card specification in field i within the set Sᵢ of almost-exact rules.

24. The method of claim 19 or 23 wherein the act of reducing further includes the acts of determining rules with non-exact fields; and
deleting said rules with non-exact fields from each set.

25. The method of claim 21 further including the acts of determining rules in each set that intersect with any other rule in the database of rules that has higher priority; and
deleting intersecting such rules from each set.
